(19) United States
(12) Patent Application Publication
(10) Pub. No.: US 2026/0310181 A1
(43) Pub. Date: Oct. 8, 2026

(54) INFORMATION OUTPUT DEVICE, INFORMATION OUTPUT METHOD, AND RECORDING MEDIUM

(71) Applicant: NEC Corporation, Tokyo (JP)

(72) Inventors: Noboru NAGATANI, Tokyo (JP); Tomoo ADACHI, Tokyo (JP); Shuichi KARINO, Tokyo (JP)

(73) Assignee: NEC Corporation, Tokyo (JP)

(21) Appl. No.: 19/481,240

(22) PCT Filed: May 30, 2023
(86) PCT No.: PCT/JP2023/020092

§ 371 Date: Nov. 4, 2025

(51) Int. Cl. G05B 19/418

(52) U.S. Cl. CPC G05B 19/4184; G05B 19/4183

(57) ABSTRACT

An information output device according to the present disclosure comprises: an information collection unit that collects at least apparatus information of different types from external information relating to managed apparatuses and to tracing of the apparatuses from manufacturing time to operation time; and an output unit that, on the basis of the apparatus information, causes a combination of risk information used in risk evaluation for the apparatuses to be outputted.

### TECHNICAL FIELD

The present disclosure relates to an information output device, an information output method, and a recording medium.

### BACKGROUND ART

Quality of a product is ensured by utilizing various pieces of information regarding a manufacturing process of the product. For example, records of inspections performed in the process of manufacturing the product, records of audits performed to verify the manufacturing process, and the like are used.

For example, PTL 1 discloses a data management system that records and manages, as processing records, operation logs, behavior logs, and environment logs in processes such as manufacturing, transportation, and storage of goods.

### CITATION LIST

### Patent Literature

PTL 1: JP 2021-140288 A

### SUMMARY OF INVENTION

### Technical Problem

However, the invention described in PTL 1 described above simply aims to record information at the same time as generation of the information. Meanwhile, it is required to find a risk to equipment under management or the like based on the recorded information. However, it is difficult to find a risk to the equipment simply by displaying the recorded information.

An example of an object of the present disclosure is to provide an information output device capable of making an administrator aware of a risk to equipment.

### Solution to Problem

One aspect of the present disclosure provides an information output device including an information collection means for collecting at least different types of equipment information from evidence from manufacturing to operation of equipment under management and external information regarding the equipment, and an output means for outputting, based on the equipment information, a combination of pieces of risk information to be used for risk evaluation of the equipment.

One aspect of the present disclosure provides an information output method including, by a computer, collecting at least different types of equipment information from evidence from manufacturing to operation of equipment under management and external information regarding the equipment, and outputting, based on the equipment information, a plurality of pieces of risk information to be used for risk evaluation of the equipment.

One aspect of the present disclosure provides a recording medium storing a program for causing a computer to execute collecting at least different types of equipment information from evidence from manufacturing to operation of equipment under management and external information regarding the equipment, and outputting, based on the equipment information, a plurality of pieces of risk information to be used for risk evaluation of the equipment.

### Advantageous Effects of Invention

An example of an effect of the present disclosure is that it is possible to provide an information output device capable of making an administrator aware of a risk to equipment.

### BRIEF DESCRIPTION OF DRAWINGS

FIG. 1 is a block diagram illustrating a configuration of an information output device according to the present disclosure.

FIG. 2 is a diagram illustrating a configuration of a corporate network of a customer including the information output device according to the present disclosure.

FIG. 3 is a diagram illustrating a hardware configuration in which the information output device according to the present disclosure is achieved by a computer device and its peripheral devices.

FIG. 4 is a flowchart illustrating an information output behavior according to the present disclosure.

FIG. 5 is a block diagram illustrating a configuration of an information output device according to the present disclosure.

FIG. 6 is a diagram for illustrating collection of equipment information and output of risk information in specific example 1. FIG. 7 is a diagram for illustrating collection of equipment information and output of risk information in specific example 2.

FIG. 8 is a diagram for illustrating collection of equipment information and output of risk information in specific example 3.

FIG. 9 is a diagram for illustrating collection of equipment information and output of risk information in specific example 4.

FIG. 10 is a diagram for illustrating collection of equipment information and output of risk information in specific example 5. FIG. 11 is a diagram for illustrating collection of equipment information and output of risk information in specific example 6.

FIG. 12 is a diagram for illustrating collection of equipment information and output of risk information in specific example 7.

FIG. 13 is a block diagram illustrating a configuration of an information output device according to the present disclosure.

FIG. 14 is a diagram for illustrating collection of equipment information and output of risk information in specific example 8.

FIG. 15 is a flowchart illustrating an information output behavior according to the present disclosure.

### EXAMPLE EMBODIMENT

Next, an example embodiment will be described in detail with reference to the drawings.

### First Example Embodiment

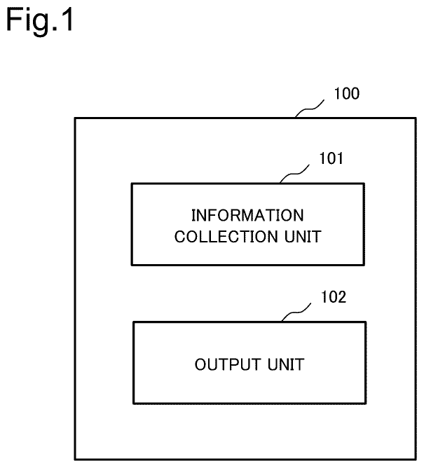

FIG. 1 is a block diagram illustrating a configuration of an information output device 100 according to the present disclosure. As illustrated in FIG. 1, the information output device 100 includes an information collection unit 101 and an output unit 102. The information output device 100 displays information regarding equipment a customer has purchased from a supplier, and causes an administrator or the like of the equipment to recognize necessity to take a countermeasure against a risk of security reliability of the equipment. In the present example embodiment, the equipment is, for example, network equipment for relaying, transferring, or the like of data through a network system.

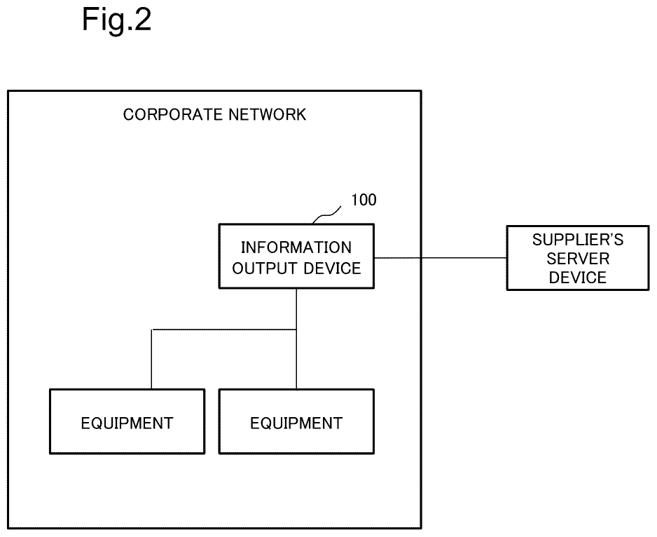

FIG. 2 is a diagram illustrating a configuration of a corporate network of the customer including the information output device 100 according to the present disclosure. As illustrated in FIG. 2, the information output device 100 is connected to the equipment the customer has purchased from the supplier in the corporate network. The information output device 100 is connected to a server device owned by the supplier by an external network.

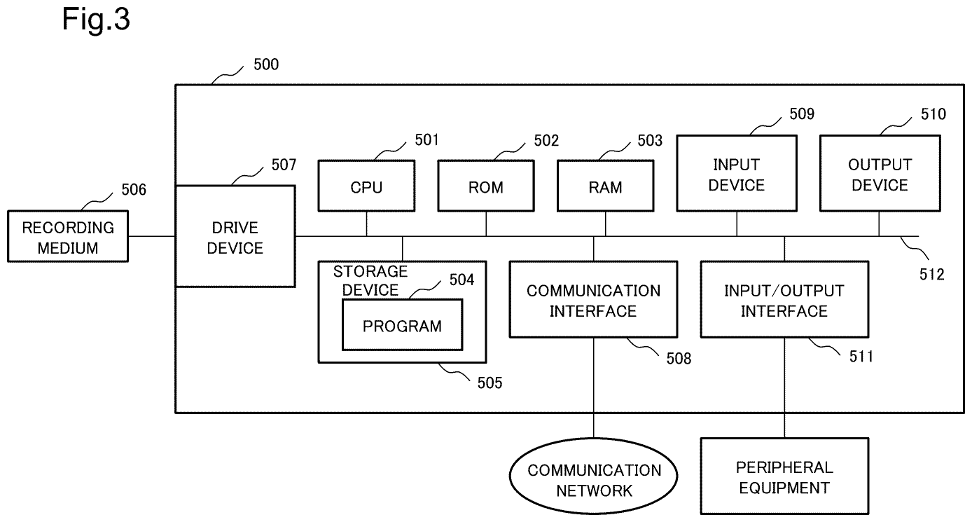

FIG. 3 is a diagram illustrating an example of a hardware configuration in which the information output device 100 of the present disclosure is implemented by a computer device 500 including a processor. As illustrated in FIG. 3, the information output device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 511 that inputs and outputs data.

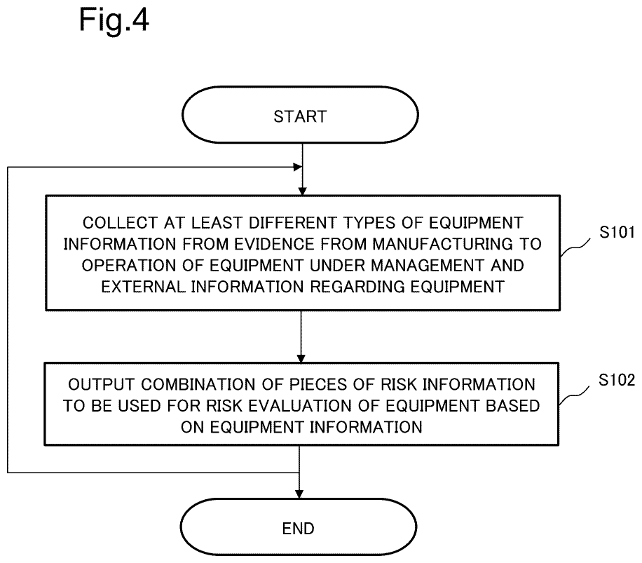

The CPU 501 runs an operating system to control the information output device 100 according to the present disclosure. The CPU 501 reads a program and data onto a memory from a recording medium 506 attached to a drive device 507 or the like, for example. The CPU 501 functions as components of the information output device 100 and a part thereof, and executes processing or a command in a flowchart illustrated in FIG. 4 to be described later, based on a program.

The recording medium 506 is an optical disc, a flexible disk, a magneto-optical disk, an external hard disk, a semiconductor memory, or the like, for example. Part of the recording medium of the storage device is a non-volatile storage device in which a program is recorded. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to check an output.

As described above, a first example embodiment illustrated in FIG. 1 is implemented by the computer hardware illustrated in FIG. 3. However, a means for implementing each component included in the information output device 100 in FIG. 1 is not limited to the configuration described above. The information output device 100 may be achieved by one physically coupled device, or may be achieved by a plurality of devices, which are two or more physically separated devices connected in a wired or wireless manner. For example, the input device 509 and the output device 510 may be connected to the computer device 500 via a network.

The information collection unit 101 is a means for collecting at least different types of equipment information from evidence from manufacturing to operation of equipment under management and external information regarding the equipment. In the present example embodiment, the evidence is information that serves as evidence objectively indicating the configuration, logs, and inspection history of equipment over a system life cycle from manufacturing to operation.

Specific examples of the evidence include equipment authenticity verification information, hardware configuration information or configuration information of software written into the equipment, a hardware or software configuration change history, operation logs of a setting change and the like during operation of the equipment, and behavior logs of a restart and the like.

For example, the information collection unit 101 collects, from the server device owned by the supplier, the evidence at the time of manufacturing of the equipment under management. The information collection unit 101 collects, for example, the evidence during operation of the equipment under management from the equipment connected through the corporate network.

The information collection unit 101 may have a function of collecting the evidence during operation of target equipment from a remote place through a network for management. In this case, the information collection unit 101 accesses a management function of the corresponding equipment and collects the evidence during operation of the equipment. The information collection unit 101 may receive log information or the like sent out by the corresponding equipment and collect the evidence during operation.

In the present example embodiment, authenticity means that the equipment has not been unintentionally modified from the state of the equipment at the time of manufacturing, and indicates that the equipment is free of impersonation, replacement, falsification, or the like.

Examples of hardware replacement include an act of replacing a genuine product with a counterfeit product during transportation. The authenticity of the hardware may be a result of verification obtained by matching information stored as data in the equipment with a serial number printed on a label on a main body or a component of the equipment.

However, a verification result obtained by matching the serial number printed on the label is less reliable than a verification result obtained by verifying a digital signature. The information collection unit 101 may collect information regarding reliability of an authenticity verification result.

The information collection unit 101 may also collect, as the equipment information, whether there are countermeasures against replacement or falsification. The information collection unit 101 collects information regarding the countermeasures against replacement or falsification from the server device owned by the supplier of the equipment, for example. Examples of the countermeasures against replacement or falsification include sealing with tape to prevent attachment of an unauthorized chip.

The authenticity of the software is verified, for example, by using secure boot to match integrity of the software by the digital signature with a publisher. Here, conditions for verifying the authenticity of the software may include that the authenticity of the hardware has been verified. Even in a case where it is not possible to verify the authenticity of the hardware, it is possible to perform processing of verifying the authenticity of the software. However, omitting to verify the authenticity of the hardware increases the possibility of fabrication of a software authenticity verification result. The information collection unit 101 may also collect, as the equipment information, whether there are countermeasures against impersonation or falsification during execution of the software. The information collection unit 101 collects information regarding the countermeasures against impersonation or falsification from the server device owned by the supplier, for example.

Examples of the countermeasures against impersonation or falsification during execution of the software include providing a function of preventing memory falsification by exploitation of a vulnerability of the software during execution.

The hardware configuration information includes at least a unique serial number and a product ID such as a model number of the main body of the equipment or a component incorporated in the equipment. Examples of the component include a CPU, a power supply, and a small form factor pluggable (SFP).

The software configuration information includes an operating system (OS) that processes the hardware, a software name of a library, an application, or the like, version information of the software, a hash value, or the like. The information collection unit 101 may collect the software configuration information from a software bill of materials (SBOM).

For the external information, the information collection unit 101 collects vulnerability information or a maintenance work schedule of the equipment stored in a management system of the equipment. The information collection unit 101 may acquire vulnerability information published on the Internet, or may acquire vulnerability information at a pre-publication stage as confidential information. The information collection unit 101 may acquire vulnerability information published via a means such as an application programming interface (API). Examples of the vulnerability information include configuration information of software in which a vulnerability has been found or an exploitation case of the vulnerability.

For example, the information collection unit 101 may collect the equipment information in response to an operation for collecting the equipment information being performed on a management screen of the equipment, or may collect the equipment information every predetermined period.

The output unit 102 is a means for outputting, based on the equipment information, a combination of pieces of risk information to be used for risk evaluation of the equipment. The risk information is information used by the administrator to determine the reliability of the equipment, and is, for example, information obtained from the equipment information such as whether the equipment has authenticity, whether there has been a change in the configuration of the equipment, whether the software has a vulnerability, whether there is an exploitation case of the vulnerability, a maintenance schedule of the equipment, or history information of the equipment. The output unit 102 outputs a combination of pieces of risk information to the output device 510 or the like. The output unit 102 may provide the risk information to another program via the API.

The output unit 102 may display pieces of the same type of risk information in time series. For example, the output unit 102 may display the authenticity information of the equipment at time of shipment and during operation in time series. The output unit 102 may display the evidence of the equipment and the external information side by side. The output unit 102 may display a quantity of equipment at risk and a temporal change in the quantity, in addition to displaying the risk information for each piece of the equipment. In a case where the quantity of equipment at risk is displayed and the quantity is selected on the screen, the output unit 102 may display the risk information for each piece of the corresponding equipment. The output unit 102 may display the risk information for each piece of the equipment in descending order of risk. During display of the risk information for each piece of the equipment, the output unit 102 may simultaneously display the evidence as a ground thereof. The output unit 102 may simultaneously display the number of risks detected during a predetermined period and the total number of currently existing risks. Specifications may be such that the administrator can change the number of risks displayed at a time, for example, 10 items at a time. The output unit 102 may hide the display of the risk information for each piece of the equipment in response to an operation being performed on the screen. As a result, it is possible to narrow down the risk information for which a countermeasure needs to be taken by excluding the risk information for which it has been determined that a countermeasure has been taken or no countermeasure needs to be taken.

A behavior of the information output device 100 configured as described above will be described with reference to the flowchart in FIG. 4.

FIG. 4 is a flowchart illustrating an outline of the behavior of the information output device 100 according to the first example embodiment. The processing according to this flowchart may be executed based on program control by the processor described above.

As illustrated in FIG. 4, first, the information collection unit 101 collects at least different types of equipment information from the evidence from manufacturing to operation of the equipment under management and the external information regarding the equipment (step S101). Next, the output unit 102 outputs, based on the equipment information, a combination of pieces of risk information to be used for risk evaluation of the equipment (step S102). The information output device 100 periodically repeats S101 to S102. Thus, the information output device 100 ends the behavior.

In the information output device 100 according to the present disclosure, the information collection unit 101 collects at least different types of equipment information from the evidence from manufacturing to operation of the equipment under management and the external information regarding the equipment, and the output unit 102 outputs, based on the equipment information, a combination of pieces of risk information to be used for risk evaluation of the equipment. This configuration makes it easier to find a risk to the reliability of the equipment that has not become apparent with a single type of equipment information, and makes it possible to make the administrator aware of the risk to the equipment.

### Modification of First Example Embodiment

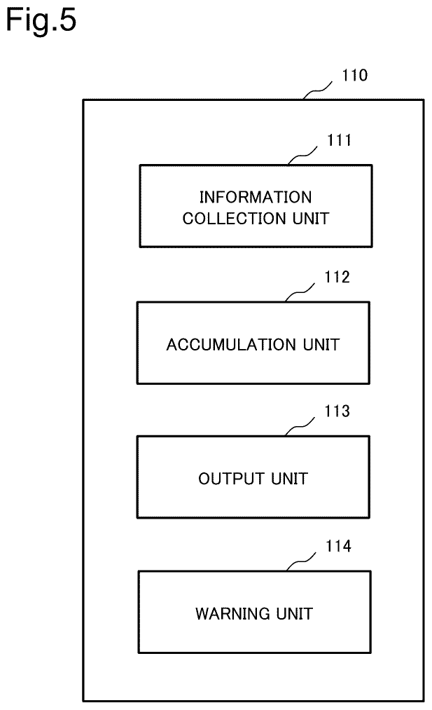

FIG. 5 is a block diagram illustrating a configuration of an information output device 110 according to the present disclosure. The information output device 110 illustrated in FIG. 5 is also implemented by the computer hardware illustrated in FIG. 3. As illustrated in FIG. 5, the information output device 110 includes an information collection unit 111, an accumulation unit 112, an output unit 113, and a warning unit 114.

The information collection unit 111 and the output unit 113 are similar to the corresponding components in the first example embodiment. In the present modification, it is assumed that there is a plurality of pieces of equipment to be managed.

The accumulation unit 112 is a means for accumulating the equipment information collected by the information collection unit 111 for each piece of the equipment. For example, in a case where there are four pieces of equipment (equipment 1 to equipment 4) to be managed, the accumulation unit 112 accumulates the equipment information in the storage device 505 for each of equipment 1 to equipment 4. The accumulation unit 112 may accumulate the equipment information in a storage area such as a blockchain where falsification of information is impossible.

The warning unit 114 is a means for giving a warning in a case where the risk information satisfies a predetermined condition. The predetermined condition is, for example, a predetermined condition under which a security risk may occur in the equipment. The warning unit 114 outputs an alert signal in a case where the risk information satisfies the predetermined condition. The warning unit 114 may display the alert by the output device 510 of the information output device 110, or may output the alert by voice. The warning unit 114 may provide the alert signal to another program via the API. Together with the alert described above, the warning unit 114 may highlight a combination of pieces of risk information that has been a ground for outputting the alert signal.

Subsequently, specific examples of collecting equipment information and outputting a combination of pieces of risk information by the information output device 100 or the information output device 110 of the present disclosure will be described with reference to the drawings, but the specific examples described in the present specification are examples and the present disclosure is not limited to these examples.

### Specific Example 1

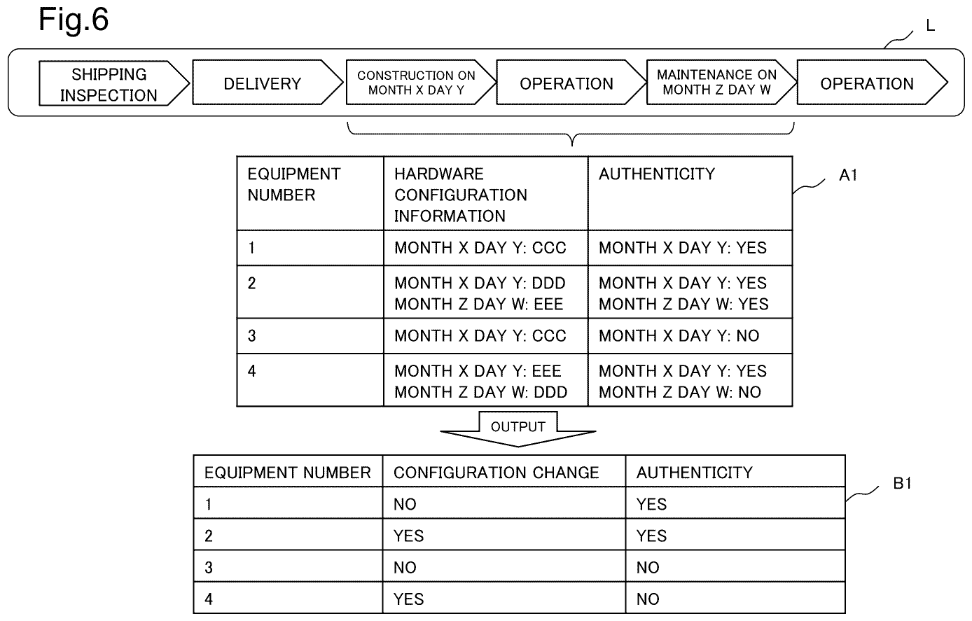

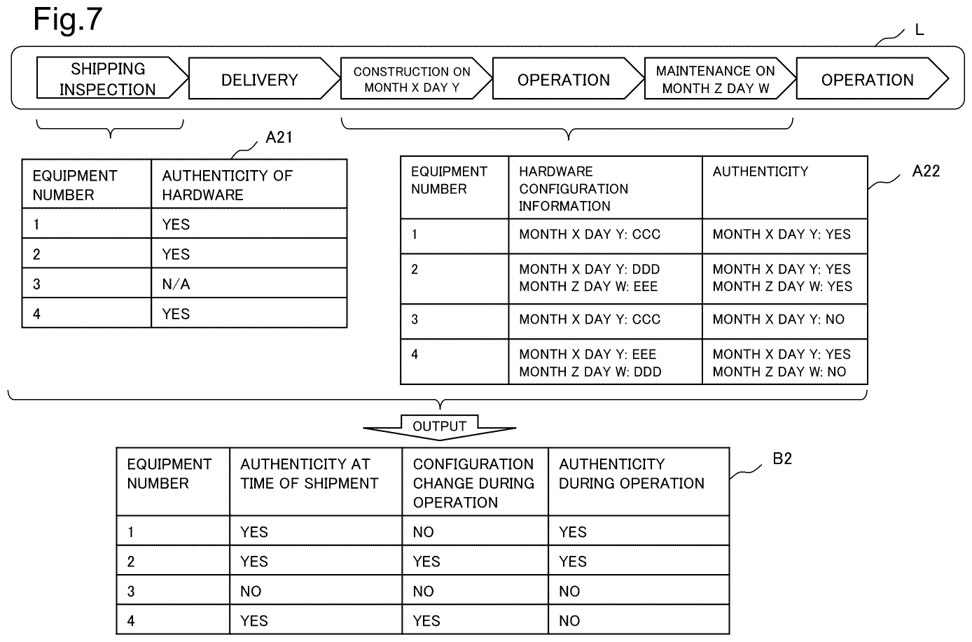

FIG. 6 is a diagram for illustrating collection of equipment information and output of risk information in specific example 1. In FIG. 6, L indicates a process in a system life cycle from manufacturing to operation of the equipment, and indicates an example of a process such as shipping inspection, delivery, construction, operation, maintenance, and operation, but process examples are not limited thereto. Al in FIG. 6 indicates an example of the equipment information of equipment 1 to equipment 4 to be managed collected by the information collection unit 111, and B1 in FIG. 6 indicates an example of a combination of pieces of risk information output by the output unit 113.

In specific example 1, the information collection unit 111 collects configuration information at different timings during operation of the equipment and authenticity verification information regarding the configuration information. The output unit 113 outputs whether there has been a change in the configuration during operation of the equipment and whether there is authenticity. Specifically, in the example in FIG. 6, the information collection unit 111 collects, as the equipment information, hardware configuration information and authenticity verification information at time of system construction on month X day Y, and at time of maintenance on month Z day W. “CCC” or the like shown in a configuration information field in Al indicates a serial number of the hardware, “YES” shown in an “AUTHENTICITY” field in Al indicates that the authenticity of the hardware has been verified, and “NO” indicates that the authenticity of the hardware has not been verified.

The reliability of the hardware configuration information depends on the authenticity of the hardware. That is, in a case where the authenticity of the hardware has not been verified, the hardware configuration information is unreliable. Therefore, in specific example 1, the information collection unit 111 collects the hardware configuration information at the time of system construction and at the time of maintenance that follows, as well as hardware authenticity verification information. Then, as illustrated in FIG. 6, the output unit 113 outputs whether there has been a change in the configuration and the authenticity verification information in the hardware for each piece of the equipment. As a result, the administrator can recognize the equipment for which a countermeasure needs to be taken against a risk such as hardware replacement. That is, the administrator can recognize that there is no risk in equipment 1 since there has been no change in the configuration of the hardware and the authenticity of the hardware has been verified. On the other hand, since equipment 2 to equipment 4 satisfy at least one of: a case where there has been a change in the configuration of the hardware; or a case where the authenticity of the hardware has not been verified, the administrator can recognize that it is necessary to take a countermeasure against a risk such as replacement.

### Specific Example 2

FIG. 7 is a diagram for illustrating collection of equipment information and output of risk information in specific example 2.

Specific example 2 will be described with reference to FIG. 7 focusing on differences from specific example 1. In specific example 2, the information collection unit 111 collects authenticity verification information regarding the configuration information at the time of shipment of the equipment, in addition to the configuration information at different timings during operation of the equipment and the authenticity verification information regarding the configuration information. The output unit 113 outputs whether there is authenticity at the time of shipment of the equipment, whether there has been a change in the configuration during operation, and whether there is authenticity during operation. Specifically, in the example in FIG. 7, the information collection unit 111 collects, as the equipment information, hardware authenticity verification information of the equipment at the time of shipment (A21), in addition to the equipment information collected in specific example 1 (A22). The output unit 113 outputs, for each piece of the equipment, a combination of whether the hardware has authenticity at the time of shipment, whether there has been a change in the configuration during operation, and whether the hardware has authenticity during operation (B2). By using the hardware authenticity verification information at the time of shipment in addition to the authenticity of the hardware during operation as in specific example 2, the administrator can confirm whether the authenticity of the hardware has been secured at the time of shipment. It can be recognized that the authenticity of the hardware has not been verified since shipment for equipment 3 in FIG. 7, whereas the authenticity of the hardware has been verified at the time of shipment for equipment 4.

In specific example 1 and specific example 2, in a case where the equipment satisfies the following (1) to (3), the warning unit 114 may warn that a risk to the reliability of the hardware has increased. That is, (1) is a case where it is not possible to verify the authenticity of the hardware. This is because the configuration of the hardware is unreliable in this case. (2) is a case where a component of the hardware has been changed to a component having no shipment history, regardless of whether the hardware has authenticity. This is because the component may be unreliable in this case. (3) is a case where the configuration of the hardware has been changed after system construction regardless of whether the hardware has authenticity. This is to prompt the administrator to confirm whether an unintended configuration change has been made in this case.

The warning unit 114 may similarly give a warning in a case where the configuration and authenticity of the software satisfy the following (4) to (6). (4) is a case where a version of software having no shipment history is running. This is because unreliable software may be running in this case. (5) is a case where it is not possible to verify the authenticity of the hardware. This is because the software configuration information is unreliable in this case. (6) is a case where the software configuration information can be listed on a component-by-component basis and the component is not in the shipment history. This is because a component such as a library may have been replaced with an unauthorized version in this case.

### Specific Example 3

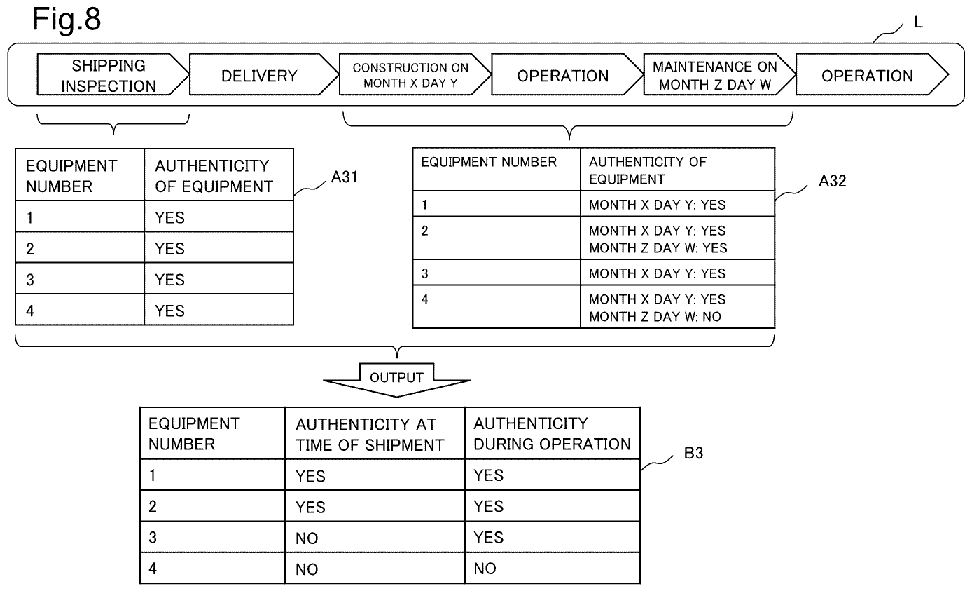

FIG. 8 is a diagram for illustrating collection of equipment 18 information and output of risk information in specific example 3. In the example in FIG. 8, the information collection unit 111 collects, as the equipment information, authenticity verification information at the time of shipment of the equipment (A31) and authenticity verification information during operation of the equipment (A32). The output unit 113 outputs a combination of whether there is authenticity at the time of shipment and whether there is authenticity during operation for each piece of the equipment (B3). In a case where identification information such as the serial number of the equipment is not authentic, there is a possibility that the equipment has been replaced. In the example in FIG. 8, the authenticity has been verified at the time of shipment for every one of equipment 1 to equipment 4, but the authenticity of equipment 4 has not been verified at the time of maintenance work on month Z day W after system construction. It is therefore possible to cause the administrator to recognize that there is a possibility that equipment 4 has been replaced during a period from system construction on month X day Y to month Z day W.

### Specific Example 4

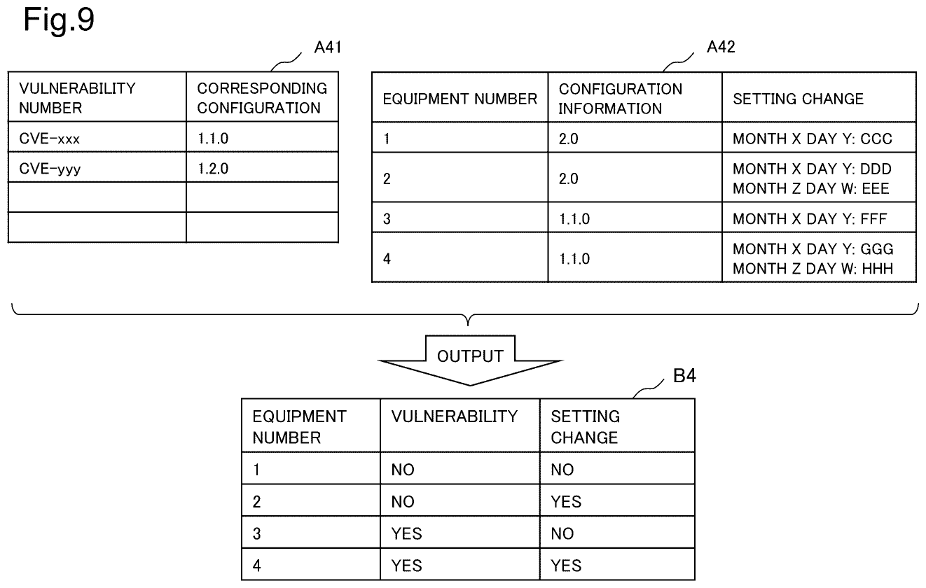

FIG. 9 is a diagram for illustrating collection of equipment information and output of risk information in specific example 4. In the example in FIG. 9, the information collection unit 111 collects, as the equipment information, configuration information of software in which a vulnerability has been found (A41), software configuration information during operation of the equipment, and setting change information of the equipment (A42). The output unit 113 outputs whether the software has a vulnerability and whether there has been a setting change for each piece of the equipment (B4). In a case where some sort of setting change has been made to the equipment embedded with software reported to have a vulnerability, there is a possibility that the setting change has been made by exploitation of the vulnerability. In the example in FIG. 9, a setting change has been made to both equipment 2 and equipment 4, but the software of equipment 2 has not been reported to have a vulnerability, whereas the software of equipment 4 has been reported to have a vulnerability. It is therefore possible to cause the administrator to recognize that there is a possibility that the setting change of equipment 2 has been made by legitimate authority and the setting change of equipment 4 has been made by exploitation of the vulnerability.

### Specific Example 5

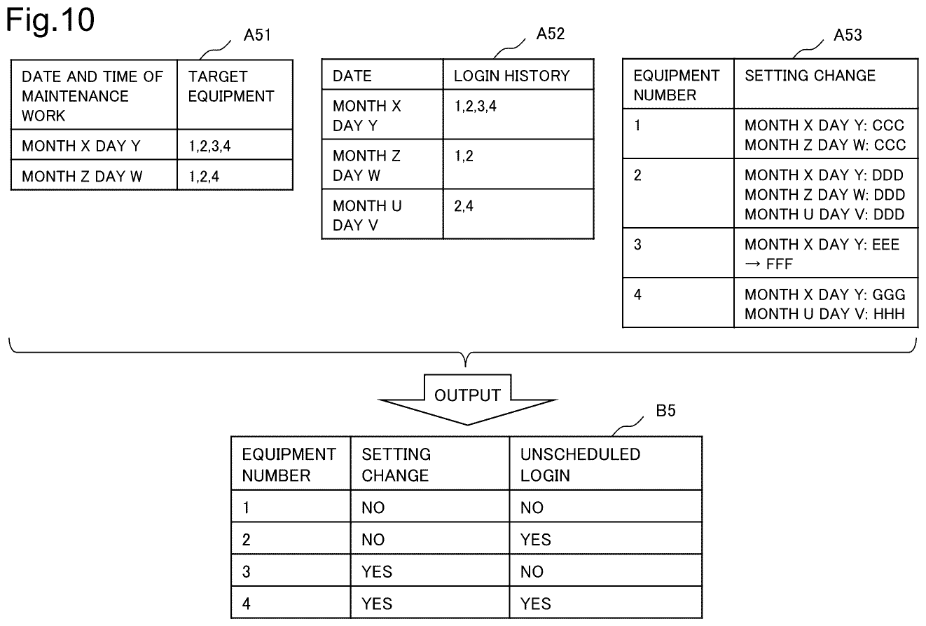

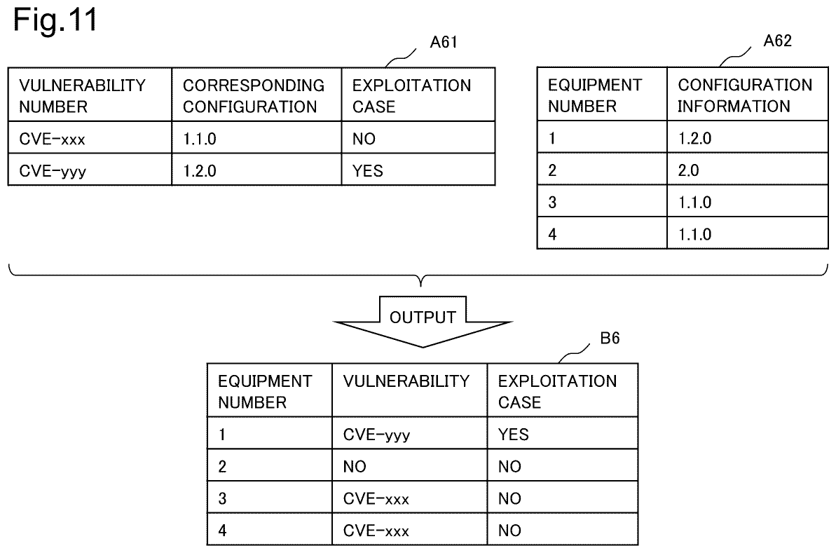

FIG. 10 is a diagram for illustrating collection of equipment information and output of risk information in specific example 5. In the example in FIG. 10, the information collection unit 111 collects, as the equipment information, information regarding scheduled maintenance work for the equipment (A51), login history of the equipment (A52), and setting change information of the equipment (A53). The output unit 113 outputs whether there has been a setting change and whether there has been an unscheduled login for each piece of the equipment (B5). In a case where there has been an unscheduled login after some sort of setting change, there is a possibility that the setting change has been installation of a back door that allows for a login by a person other than the administrator. In the example in FIG. 10, in equipment 1, there have been logins on maintenance work days (month X day Y, and month Z day W), and there has been no setting change. In equipment 2, there has been an unscheduled login on a day (month U day V) that is not a maintenance work day, but no setting change has been made. In equipment 3, there has been a login on a maintenance work day (month X day Y), and a scheduled setting change has been made. In equipment 4, there has been a login on a day (month U day V) that is not a scheduled work day, and there has been a setting change. Therefore, the administrator can recognize a possibility that a back door has been installed by an unauthorized setting change in equipment 4.

### Specific Example 6

FIG. 11 is a diagram for illustrating collection of equipment information and output of risk information in specific example 6. In specific example 6, the information collection unit 111 collects configuration information of software in which a vulnerability has been found, an exploitation case of the vulnerability, and software configuration information of the equipment. Specifically, as illustrated in FIG. 11, the information collection unit 111 collects, as the equipment information, a vulnerability number for identifying vulnerability information, configuration information of the corresponding software, an exploitation case of the vulnerability (A61), and software configuration information of the equipment (A62). The output unit 113 outputs whether the software has a vulnerability and whether there is an exploitation case of the vulnerability for each piece of the equipment (B6). Equipment embedded with software for which an exploitation case has been reported, the software being among pieces of vulnerable software, needs the administrator to preferentially take a countermeasure. In the example in FIG. 10, an exploitation case has been reported for a vulnerability number “CVE-yyy” corresponding to the configuration of the software embedded in equipment 1. Therefore, the administrator can recognize that it is necessary to preferentially take a countermeasure for equipment 1.

### Specific Example 7

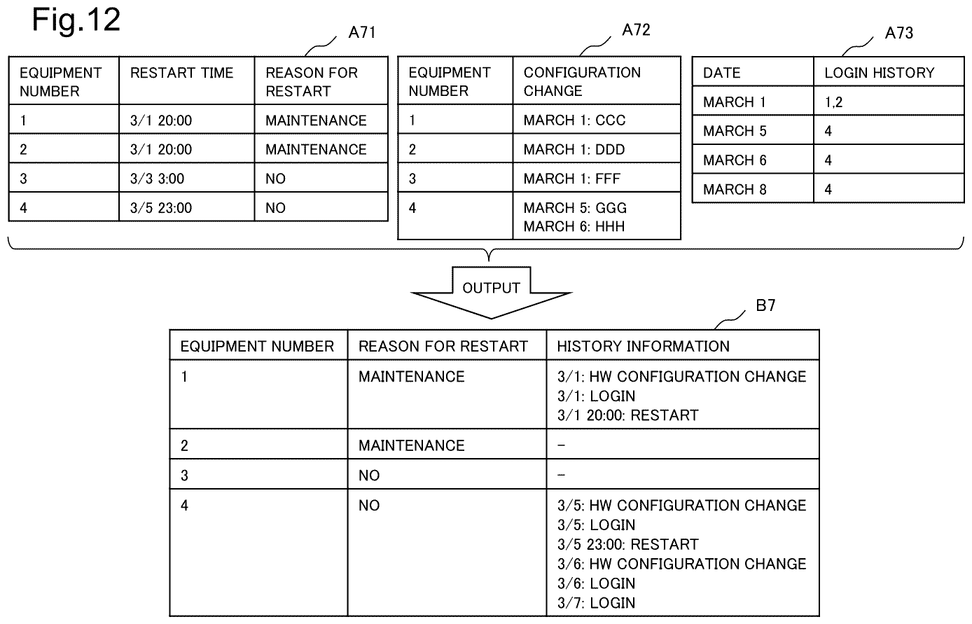

FIG. 12 is a diagram for illustrating collection of equipment information and output of risk information in specific example 7. In specific example 7, the information collection unit 111 collects, as the equipment information, time of a restart of the equipment, a reason for the restart, and history information. Specifically, as illustrated in FIG. 12, the information collection unit 111 collects, as the equipment information, time of a restart and a reason for the restart for each piece of the equipment (A71), configuration change information for each piece of the equipment (A72), and login history of equipment 1 to equipment 4 (A73). The output unit 113 outputs the reason why the restart has been performed and the history information such as a configuration change or a login before and after the restart for each piece of the equipment (B7). In a case where unauthorized software has been installed, restart may be performed to enable behaviors of the unauthorized software. It is therefore possible to cause the administrator to recognize presence of the unauthorized software by outputting information that there have been frequent logins or setting changes before and after restart, not as part of maintenance work, as in equipment 4.

### Specific Example 8

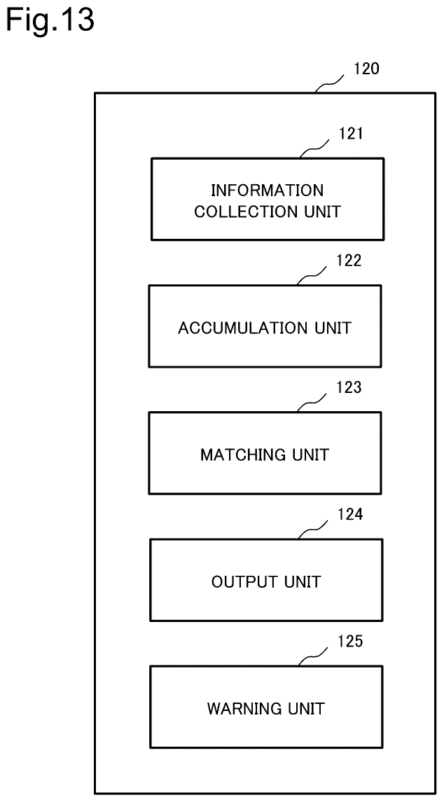

FIG. 13 is a block diagram illustrating a configuration of an information output device 120 according to the present disclosure. The information output device 120 illustrated in FIG. 13 is also implemented by the computer hardware illustrated in FIG. 3. As illustrated in FIG. 13, the information output device 120 includes an information collection unit 121, an accumulation unit 122, a matching unit 123, an output unit 124, and a warning unit 125.

In the information output device 120 in specific example 8, the information collection unit 121 collects an external attack pattern on equipment to be managed and a countermeasure, and history information of the equipment to be managed. The attack pattern is, for example, history information regarding a method used during an external attack equipment to be managed or equipment incorporated in another system received in the past, and may be history information generated across a plurality of pieces of equipment. The history information includes software vulnerability information and Common Weakness Enumeration (CWE), in addition to operation logs of a login, a setting change, and the like, and behavior logs of a restart and the like.

The accumulation unit 122 accumulates the history information of the equipment under management. The matching unit 123 matches a recorded attack pattern with the history information of the equipment. In a case where the recorded attack pattern and the history information of the equipment match up, the matching unit 123 outputs information of the matched attack pattern to the output unit 124. Then, the output unit 124 outputs the attack pattern and the countermeasure.

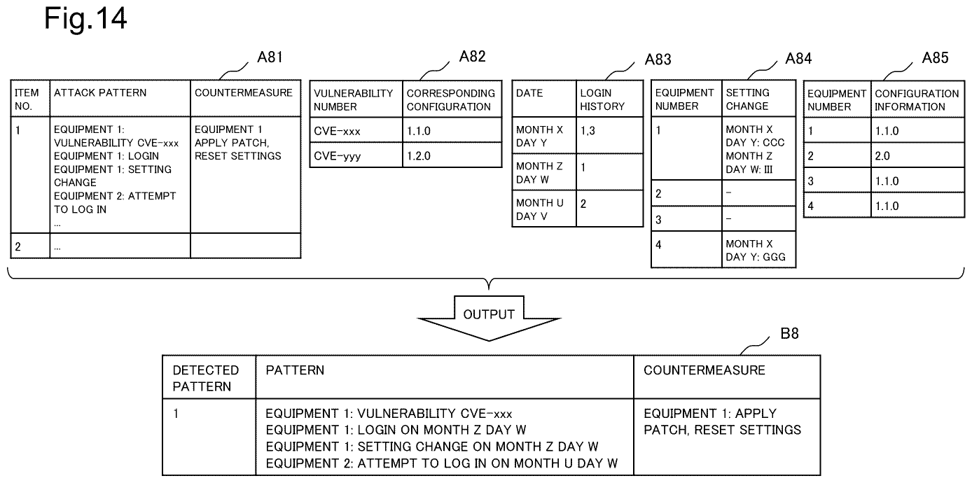

FIG. 14 is a diagram for illustrating collection of equipment information and output of risk information in specific example 8. In specific example 8, a past external attack pattern and a countermeasure are stored, and in a case where a similar attack pattern is confirmed in the equipment to be managed, the attack pattern and the countermeasure are output. In the example in FIG. 14, the information collection unit 111 collects an attack pattern and a countermeasure (A81), vulnerability information (A82), login history of equipment 1 to equipment 4 (A83), setting change information (A84), and software configuration information of equipment 1 to equipment 4 (A85). In a case where the attack pattern and the history information of the equipment to be managed match up, the output unit 124 outputs the external attack pattern and the countermeasure. In this case, the warning unit 125 may output an alert signal. As a result, in a case where there is a possibility of having received an attack similar to the attack pattern of the external attack received in the past, it is possible to notify the administrator of the countermeasure.

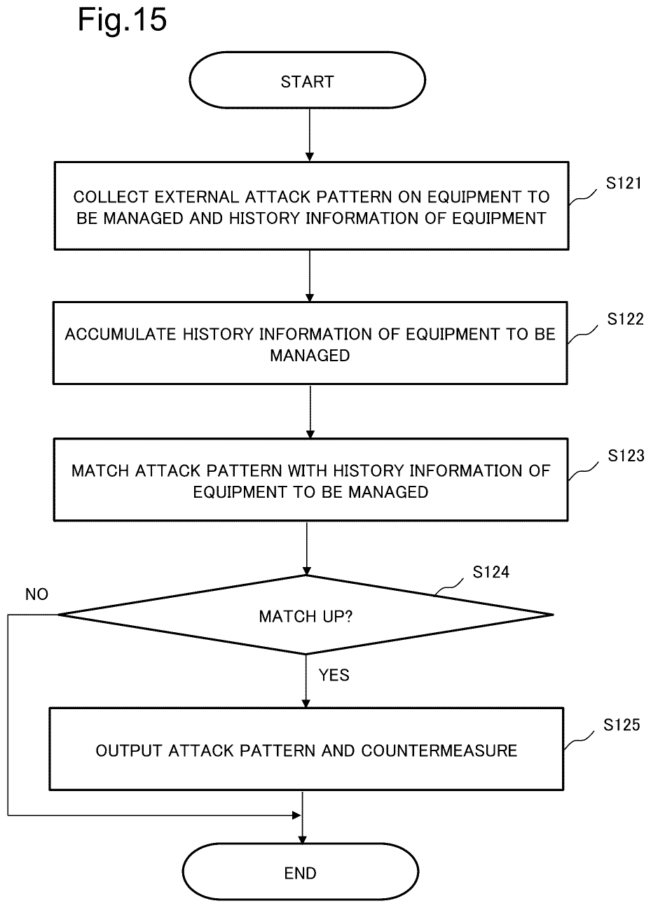

A behavior of the information output device 120 configured as described above will be described with reference to a flowchart in FIG. 15.

FIG. 15 is a flowchart illustrating an outline of the behavior of the information output device 120 of the present disclosure. The processing according to this flowchart may be executed based on program control by the processor described above.

As illustrated in FIG. 15, first, the information collection unit 121 collects an external attack pattern on the equipment to be managed and a countermeasure, and history information of the equipment (step S121).

Next, the accumulation unit 122 accumulates the history information of the equipment to be managed (step S122). Next, the matching unit 123 matches the attack pattern with the history information of the equipment to be managed (step S123). If the attack pattern and the history information match up (YES in S124), the output unit 124 outputs the attack pattern and the countermeasure (step S125). On the other hand, if the attack pattern and the history information of the equipment to be managed do not match up (NO in S124), the flow ends. Thus, the information output device 120 ends the behavior.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

For example, while a plurality of behaviors is described in order in the form of a flowchart, the described order does not limit the order in which the plurality of behaviors is executed. Therefore, in a case where each example embodiment is implemented, the order of the plurality of behaviors can be changed within a range that does not interfere with the content.

Some or all of the example embodiments described above may also be described as, but are not limited to, the following supplementary notes.

### (Supplementary Note 1)

An information output device including:
an information collection means for collecting at least different types of equipment information from evidence from manufacturing to operation of equipment under management and external information regarding the equipment; and
an output means for outputting, based on the equipment information, a combination of pieces of risk information to be used for risk evaluation of the equipment.

### (Supplementary Note 2)

The information output device according to supplementary note 1, further including: an accumulation means for accumulating the equipment information for each piece of the equipment.

### (Supplementary Note 3)

The information output device according to supplementary note 1or 2, further including: a warning means for giving a warning in a case where the risk information satisfies a predetermined condition.

### (Supplementary Note 4)

The information output device according to supplementary note 3, in which the warning means gives a warning in a case where at least one of following is satisfied: it is not possible to verify authenticity of hardware of the equipment; a component of the hardware has been changed to a component having no shipment history; or a configuration of the equipment has been changed after system construction.

### (Supplementary Note 5)

The information output device according to any one of supplementary notes 1 to 4, in which
the information collection means collects configuration information at different timings during the operation of the equipment and authenticity verification information regarding the configuration information, and
the output means outputs whether there has been a change in the configuration during the operation of the equipment and whether there is the authenticity.

### (Supplementary Note 6)

The information output device according to supplementary note 5, in which
the information collection means further collects authenticity verification information regarding the configuration information at time of shipment of the equipment, and
the output means outputs whether there is the authenticity at the time of the shipment of the equipment, whether there has been a change in the configuration during the operation, and whether there is the authenticity during the operation.

### (Supplementary Note 7)

The information output device according to any one of supplementary notes 1 to 3, in which
the information collection means collects authenticity verification information at time of shipment of the equipment and authenticity verification information during the operation of the equipment, and
the output means outputs whether there is authenticity at the time of the shipment of the equipment and whether there is the authenticity during the operation.

### (Supplementary Note 8)

The information output device according to any one of supplementary notes 1 to 3, in which
the information collection means collects configuration information of software in which a vulnerability has been found, software configuration information of the equipment, and setting change information of the equipment, and t
he output means outputs whether the software of the equipment has the vulnerability and whether there has been a setting change.

### (Supplementary Note 9)

The information output device according to any one of supplementary notes 1 to 3, in which
the information collection means collects information regarding work scheduled for the equipment, login history, and setting change information, and
the output means outputs whether there has been a setting change in the equipment and whether there has been an unscheduled login.

### (Supplementary Note 10)

The information output device according to any one of supplementary notes 1 to 3, in which
the information collection means collects configuration information of software in which a vulnerability has been found, an exploitation case of the vulnerability, and software configuration information of the equipment, and
the output means outputs whether the software of the equipment has the vulnerability and whether there is the exploitation case of the vulnerability.

### (Supplementary Note 11)

The information output device according to any one of supplementary notes 1 to 3, in which
the information collection means collects time of a restart of the equipment, a reason for the restart, and history information, and
the output means outputs the reason for the restart and the history information before and after the restart.

### (Supplementary Note 12)

The information output device according to any one of supplementary notes 1 to 3, further including:
a matching means for matching an external attack pattern on the equipment with history information of the equipment, in which
the information collection means collects the attack pattern, a countermeasure, and the history information of the equipment, and
the output means outputs the attack pattern and the countermeasure in a case where the attack pattern and the history information match up.

### (Supplementary Note 13)

An information output method including:
by a computer,
collecting at least different types of equipment information from evidence from manufacturing to operation of equipment under management and external information regarding the equipment; and
outputting, based on the equipment information, a plurality of pieces of risk information to be used for risk evaluation of the equipment.

### (Supplementary Note 14)

A recording medium storing a program for causing a computer to execute:
collecting at least different types of equipment information from evidence from manufacturing to operation of equipment under management and external information regarding the equipment; and
outputting, based on the equipment information, a plurality of pieces of risk information to be used for risk evaluation of the equipment.

### REFERENCE SIGNS LIST

100, 110, 120 information output device
101, 111, 121 information collection unit
102, 113, 124 output unit
112, 122 accumulation unit
114, 125 warning unit
123 matching unit
500 computer device
501 CPU
502 ROM
503 RAM
504 program
505 storage device
506 recording medium
507 drive device
508 communication interface
509 input device
510 output device
511 input/output interface
512 bus

What is claimed is:

1. An information output device comprising:
one or more memories storing instructions; and
one or more processors configured to execute the instructions to:
collect at least different types of equipment information from evidence from manufacturing to operation of equipment under management and external information regarding the equipment; and
output, based on the equipment information, a combination of pieces of risk information to be used for risk evaluation of the equipment.

2. The information output device according to claim 1, wherein the one or more processors are further configured to execute the instructions to accumulate the equipment information for each piece of the equipment.

3. The information output device according to claim 1, wherein the one or more processors are further configured to execute the instructions to give a warning in a case where the risk information satisfies a predetermined condition.

4. The information output device according to claim 3, wherein the one or more processors are configured to execute the instructions to give a warning in a case where at least one of following is satisfied: it is not possible to verify authenticity of hardware of the equipment; a component of the hardware has been changed to a component having no shipment history; or a configuration of the equipment has been changed after system construction.

5. The information output device according to claim 1, wherein the one or more processors are configured to execute the instructions to:
collect configuration information at different timings during the operation of the equipment and authenticity verification information regarding the configuration information; and
output whether there has been a change in the configuration during the operation of the equipment and whether there is the authenticity.

6. The information output device according to claim 5, wherein the one or more processors are further configured to execute the instructions to:
collect authenticity verification information regarding the configuration information at time of shipment of the equipment; and
output whether there is the authenticity at the time of the shipment of the equipment, whether there has been a change in the configuration during the operation, and whether there is the authenticity during the operation.

7. The information output device according to claim wherein the one or more processors are configured to execute the instructions to:
collect authenticity verification information at time of shipment of the equipment and authenticity verification information during the operation of the equipment; and
output whether there is authenticity at the time of the shipment of the equipment and whether there is the authenticity during the operation.

8. The information output device according to claim 1, wherein the one or more processors are configured to execute the instructions to:
configuration information of software in which a vulnerability has been found, software configuration information of the equipment, and setting change information of the equipment; and
output whether the software of the equipment has the vulnerability and whether there has been a setting change.

9. The information output device according to claim 1, wherein the one or more processors are configured to execute the instructions to:
collect information regarding work scheduled for the equipment, login history, and setting change information; and
output whether there has been a setting change in the equipment and whether there has been an unscheduled login.

10. The information output device according to claim 1, wherein the one or more processors are configured to execute the instructions to:
collect configuration information of software in which a vulnerability has been found, an exploitation case of the vulnerability, and software configuration information of the equipment; and
output whether the software of the equipment has the vulnerability and whether there is the exploitation case of the vulnerability.

11. The information output device according to claim 1, wherein the one or more processors are configured to execute the instructions to:
collect time of a restart of the equipment, a reason for the restart, and history information; and
output the reason for the restart and the history information before and after the restart.

12. The information output device according to claim 1, wherein the one or more processors are further configured to execute the instructions to:
a matching match an external attack pattern on the equipment with history information of the equipment;
collect the attack pattern, a countermeasure, and the history information of the equipment; and
output the attack pattern and the countermeasure in a case where the attack pattern and the history information match up.

13. An information output method comprising:
by a computer,
collecting at least different types of equipment information from evidence from manufacturing to operation of equipment under management and external information regarding the equipment; and
outputting, based on the equipment information, a combination of pieces of risk information to be used for risk evaluation of the equipment.

14. A non-transitory recording medium storing a program for causing a computer to execute:
collecting at least different types of equipment information from evidence from manufacturing to operation of equipment under management and external information regarding the equipment; and
outputting, based on the equipment information, a combination of pieces of risk information to be used for risk evaluation of the equipment.
